(19) United States
(12) Patent Application Publication
(10) Pub. No.: US 2020/0359704 A1
(43) Pub. Date: Nov. 19, 2020

(54) MICROPOROUS CERAMIC THICK-FILM HEATING ELEMENT FOR ELECTRONIC CIGARETTE OIL ATOMIZING CORE, AND MANUFACTURING METHOD THEREOF

(71) Applicant: Dongguang TPS Electronic Technology Co., Ltd., DongGuan (CN)

(72) Inventor: Jinfu DENG, Dongguan (CN)

(21) Appl. No.: 16/447,179

(22) Filed: Jun. 20, 2019

(30) Foreign Application Priority Data
May 14, 2019 (CN) 201910398841.5

(51) Int. Cl. A24F 47/00; H05B 3/16; H05B 3/46

(52) U.S. Cl. CPC A24F 47/008; H05B 2203/017; H05B 3/46; H05B 3/16

(57) ABSTRACT

Disclosed are a microporous ceramic thick-film heating element for an electronic cigarette oil atomizing core and its manufacturing method. The microporous ceramic thick-film heating element includes a microporous ceramic substrate, a heating resistive layer and an electrode layer, and the heating resistive layer has a middle portion and two connecting portions, and the electrode layer includes two separated electrode films, and the two connection parts are connected to upper ends of the two electrode films respectively, and the middle portion is coupled to an upper surface of the microporous ceramic substrate, and the heating resistive layer is provided for heating microporous ceramic substrate to atomize a smoke oil of an electronic cigarette and disperse the atomized smoke oil from micropores of the microporous ceramic substrate to the outside.

### FIELD OF THE INVENTION

The present invention relates to the field of electronic cigarettes, in particular to a microporous ceramic thick-film heating element for an electronic cigarette oil atomizing core and its manufacturing method.

### BACKGROUND OF THE INVENTION

Smoke oil type electronic cigarette is a virtual cigarette which is a substitute product of the traditional cigarette. The structure of the electronic cigarette generally comprises an electronic atomizer (including a smoke oil and heating/atomizing part), and a cigarette body (including a battery, a control circuit, and an airflow sensor component). The operating principle is to connect the battery to a heating element of an atomizer through the control circuit and airflow sensor part in the cigarette body and apply a voltage to the heating element of the atomizer until the temperature of the heating element rises to 130° C.˜150° C., so as to atomize smoke oil solution including nicotine, special tobacco flavor, propylene glycol, vegetable glycerin contained in an oil tank of an atomizer into particles which are mixed into a sucked airflow to form an aerosol, so as to simulate smoke.

Compared with traditional cigarettes that produce thousands of carcinogenic harmful compounds such as tar, carbon monoxide, nitrosamine, and radioactive substances at high temperature while burning the tobacco, the smoke oil type electronic cigarette basically contains nicotine and edible glycerin in the smoke while atomizing a smoke oil to satisfy the physiological and psychological needs of smoking consumers. Therefore, the smoke oil type electronic cigarette can reduce the impacts on jeopardizing the health of the smoking consumers and affecting the public environment.

After several years of development, the heating element used in domestic and foreign smoke oil type electronic cigarette atomizers are generally categorized into the following types according to the chronological order of development: a first-generation atomizer heating element having a nickel-chromium alloy heating wire wound by an oil guide cotton or a fiberglass string; a second-generation atomizer heating element having a nickel-chromium alloy heating wire wound by a porous ceramic; and a third-generation atomizer heating element having a nickel-chromium alloy heating wire buried into a porous ceramic, wherein these three atomizer heating elements are shown in FIGS. 1 to 3 respectively.

In the first-generation atomizer heating element, the nickel-chromium alloy heating wire is wound around the exterior or the interior of the oil guide cotton or fiberglass string. The atomizer heating element of this type has the following drawbacks: 1. There is a risk of inhaling fine filaments of the fiberglass string into a consumer's lung. 2. The oil guide cotton or fiberglass string may be burned or charred at the operating temperature of the electronic cigarette to produce carcinogens and jeopardize human's physical health and reduce the safety of the atomizer 3. The heating wire has a small heating area, a high operating temperature, a high possibility of carbonizing the smoke oil, producing bad odor, and affecting the taste of the vapor of the electronic cigarette and the service life.

In the second-generation atomizer heating element, a porous ceramic manufactured by high-temperature sintering is used to substitute the oil guide cotton or fiberglass string, and the nickel-chromium alloy heating wire is wound around the exterior of the porous ceramic. Although the second-generation atomizer can avoid the coking of the oil guide cotton or fiberglass string of the first-generation atomizer to a certain extent, yet the second-generation atomizer heating element still has the following drawbacks. Since the nickel-chromium alloy heating wire is wound around the exterior of the porous ceramic, and the heating wire and the microporous ceramic substrate are not in sufficient contact with each other, therefore the heating wire cannot be fully dipped into the smoke oil, and the portion not dipped into the smoke oil will be situated at a dry-burn state, and the operating temperature of the heating wire will be too high and thus causing a burned smell of the smoke oil and affecting the taste of the vapor of the electronic cigarette significantly.

In the third-generation atomizer heating element, the nickel-chromium alloy heating wire is buried into a porous ceramic green part in an integral injection molding process, and both of the porous ceramic green part and the nickel-chromium alloy heating wire are put together and sintered at a temperature around 600° C. to produce the third-generation atomizer heating element. The nickel-chromium alloy heating wire of the atomizer heating element of this sort is buried into the porous ceramic, so that the issue of the second-generation atomizer heating element insufficiently dipped into the smoke oil can be overcome. However, the nickel-chromium alloy heating wire will be oxidized and blackened during the sintering at the high temperature above 1300° C., so that the heating property and the resistive property will be affected. To prevent the nickel-chromium alloy heating wire from being oxidized or blackened by the high temperature of the sintering process, the sintering temperature used for sintering the porous ceramic is decreased from 1300° C. to 600° C. As a result, the porous ceramic of the atomizer heating element of this type has a too-low sintering temperature an insufficient strength of the ceramic body and results in a loose structure. When the porous ceramic heater is dipped into the smoke oil for a long time, porcelain powder of the porous ceramic may be formed easily, and the peeled porcelain powder may be inhaled into a consumer's lung. In the meantime, the heating wire buried into the porous ceramic, so that carbon may be accumulated to block the micropores of the porous ceramic easily during the operating process, and the smoke oil may be burned or charred to affect the taste and reduction of the smoke oil.

In summation, the oil guide cotton or fiberglass string of the conventional first-generation atomizer heating element wound around the nickel-chromium alloy heating wire, and the porous ceramic of the second-generation the conventional atomizer heating element wound around the nickel-chromium alloy heating wire, and the porous ceramic of the conventional third-generation atomizer heating element buried with the nickel-chromium alloy heating wire still have drawbacks and problems and cannot meet the requirements of the atomizer heating element for the electronic cigarette product.

In view of the aforementioned drawbacks of the conventional water transfer printing, the inventor of the present invention based on years of experience in the related industry to conduct extensive research and experiment, and finally provided the present invention to overcome the drawbacks of the prior art.

### SUMMARY OF THE INVENTION

To overcome the drawbacks and deficiencies of the aforementioned prior arts, the present invention provides a microporous ceramic thick-film heating element for an electronic cigarette oil atomizing core, and the microporous ceramic thick-film heating element has the advantages of safe and reliable use, long service life, high degree of reduction of the smoke oil, and good taste.

Another objective of the present invention is to provide a manufacturing method of a microporous ceramic thick-film heating element for an electronic cigarette oil atomizing core, and the manufacturing method has the advantages of simple, highly efficient and convenient operation and control, easy mass production, stable quality, and long service life.

To achieve the aforementioned and other objectives, the present invention discloses a microporous ceramic thick-film heating element for an electronic cigarette oil atomizing core, comprising: a microporous ceramic substrate, a heating resistive layer and an electrode layer coupled to an upper surface of the microporous ceramic substrate, and the heating resistive layer including a middle portion and two connecting portions disposed at both ends of the middle portion respectively, and the electrode layer including two separated electrode films, and the two connection parts being coupled to upper ends of the two electrode films respectively, and the middle portion being coupled to an upper surface of the microporous ceramic substrate; the heating resistive layer being provided for heating the microporous ceramic substrate to atomize a smoke oil of an electronic cigarette and discharge the atomized smoke oil from the microporous ceramic substrate to the outside.

In the present invention, the electrode layer and the heating resistive layer are formed on the microporous ceramic substrate, and the microporous ceramic substrate has high strength, so that the porcelain powder will not be formed easily when the microporous ceramic substrate is dipped into the smoke oil for a long time. The heating resistive layer and the electrode film are coupled to the microporous ceramic material, so that the microporous ceramic material is capable of adsorbing and guiding the smoke oil and fully infiltering the heating resistive layer to provide good atomization effect and high degree of reduction of the smoke oil. In the present invention, the microporous ceramic thick-film heating element is installed to a main body of the electronic cigarette, and the smoke oil of the electronic cigarette is dipped into the micropore of the microporous ceramic substrate, and the micropore forms a smoke oil atomization channel. When the electronic cigarette is in use, the heating resistive layer heats the microporous ceramic substrate to atomize the smoke oil of the electronic cigarette and disperse the atomized smoke oil from the micropore of the microporous ceramic substrate to the outside. When the electronic cigarette is not in use, the smoke oil is stored in the microporous ceramic substrate without spilling out, so that the electronic cigarette is ready for use anytime.

Further, the electrode film is printed onto an upper surface of the ceramic carrier, and the electrode film and the microporous ceramic substrate are sintered and coupled together, and the heating resistive layer is printed on the an upper surface of the microporous ceramic substrate and an upper surface of the electrode film, and the heating resistive layer is sintered and coupled to the electrode film and the microporous ceramic substrate.

Further, the microporous ceramic thick-film heating element further comprises two lead pins, and the microporous ceramic substrate has two positioning blind holes and two electrode films disposed above respectively, and lower ends of the two lead pins are passed through the two electrode films, inserted into the two positioning blind holes respectively and soldered with the two electrode films respectively. With the aforementioned structure, the configuration of the positioning blind hole and the lead pin allows the lead pin to be installed to a precise position of the microporous ceramic substrate quickly to improve the installation efficiency of the lead pin.

Further, the microporous ceramic thick-film heating element further comprises two separated silver paste soldering portions, and lower ends of the two silver paste soldering portions are coupled to upper surfaces of the two electrode films respectively, and lower ends of the two lead pins are passed sequentially through the corresponding silver paste soldering portion and electrode film and inserted into the two positioning blind holes respectively. The silver paste soldering portion is used for sintering and fixing the lead pin to the electrode layer and the microporous ceramic thick-film, so that the electrode layer can be electrically conducted with the lead pin and the heating resistive layer.

Further, the microporous ceramic substrate has a storage blind slot concavely formed at the bottom of the microporous ceramic substrate and provided for receiving a smoke oil of an external electronic cigarette, and the heating resistive layer is provided for heating the microporous ceramic substrate to atomize the smoke oil contained in the storage blind slot and dispersing from a micropore to the outside. The storage blind slot is provided for storing the smoke oil and guiding the oil.

Further, the storage blind slot is in a prismatic, truncated, or elliptical shape, and the lower end of the storage blind slot has a hole diameter greater than the hole diameter of the upper end of the storage blind slot. With the aforementioned structure, the smoke oil can be added into the storage blind slot conveniently.

Further, the microporous ceramic thick-film heating element further comprises two separate silver paste soldering portions, and lower ends of the two silver paste soldering portions are coupled to upper surfaces of the two electrode films respectively, and lower ends of the two lead pins are passed through the corresponding silver paste soldering portions and electrode films and inserted into the two positioning blind holes respectively. The silver paste soldering portion is used for sintering and fixing the lead pin to the electrode layer and the microporous ceramic thick-film.

Further, the microporous ceramic substrate is in an inverted hollow T-shape, and a boss is formed at the middle of the upper end of the microporous ceramic substrate, wherein the electrode film, the heating resistive film, and the silver paste soldering portion are disposed at the boss, and the two positioning blind holes are symmetrically formed on the boss. The microporous ceramic substrate is installed to the main body of the electronic cigarette conveniently for a convenient use.

Further, the middle portion is S-shaped, and the connecting portion has a width greater than the width of the middle portion, and the electrode film has a width greater than the width of the connecting portion. Since the width of the connecting portion is increased, the connecting portion can be coupled to the electrode film securely, and the electrode film has a cross-sectional area greater than the size of the positioning blind hole to guarantee that the lead pin can extend into the positioning blind hole after passing through the electrode film, so that the external surface of the electrode lead can be electrically conducted with the electrode film very well.

Further, the heating resistive layer has a thickness of 50˜60 μm. The electrode film has a thickness of 18˜22 μm. The silver paste soldering portion and the electrode layer can be electrically conducted with the lead pin and the heating resistive layer. The heating resistive layer is a layered structure. By setting the thickness of the heating resistive layer and the thickness of the electrode film, the electrode film has good conductivity and adhesiveness, so that the heating resistive layer and the electrode film can be coupled to the microporous ceramic substrate tightly without the risk of falling off easily, and the heating resistive layer has little heat accumulated inside and high atomization efficiency.

Further, the microporous ceramic substrate has a through porosity of 50˜60%, and the micropore has a hole diameter of 10˜20 μm.

To achieve the aforementioned and other objectives, the present invention further discloses a manufacturing method of a microporous ceramic thick-film heating element for an electronic cigarette oil atomizing core, and the manufacturing method comprises the following steps:

(1) Prepare a microporous ceramic substrate.

(2) Print a material used for manufacturing an electrode layer on an upper surface of the microporous ceramic substrate, and bake/dry the printed electrode wet film to obtain an electrode initial layer.

(3) Sinter the baked/dried electrode initial layer to obtain an electrode layer, wherein the electrode layer includes two separate electrode films.

(4) Use a thick film formation process to print a heating resistive wet film on an upper surface of the microceramic substrate and an upper surface of the electrode layer, and connect two connection parts of the heating resistive wet film to upper surfaces of the two electrode films respectively, and bake/dry the printed heating resistive wet film.

(5) Use a thick film formation process or an adhesive dispensing process and apply a silver solder paste onto upper surfaces of the two electrode films and at positions corresponding to the areas around the positioning blind hole to prepare a silver paste soldering portion, and pass a lead pin through the silver paste soldering portion and the electrode film sequentially and insert the lead pin into the positioning blind hole to obtain a microporous ceramic thick-film heating element semi-finished product, and put the microporous ceramic thick-film heating element semi-finished product into a drying furnace for baking/drying.

(6) Sinter the baked/dried microporous ceramic thick-film heating element semi-finished product.

(7) Perform a precision processing of the microporous ceramic thick-film heating element semi-finished product and use performance test and external inspection to obtain a microporous ceramic thick-film heating element.

In the step (1), the microporous ceramic substrate has a through porosity of 50˜60%, and the micropore has a hole diameter of 10˜20 μm. Further, the microporous ceramic substrate is made by a sintering process at a high temperature above 1300° C., and can completely be used for preparing a carrier green part in the microporous ceramic substrate and burning a pore-forming agent and an organic binder to obtain a powerful strength, a powder-free product, and an odorless microporous ceramic substrate. In the present invention, the through porosity of the microporous ceramic substrate and the hole diameter of the micropore are set and a high sintering temperature is used, so that the microporous ceramic material can suck and guide the smoke oil smoothly. Since eutectic bonds are bonded. The heating resistive layer and the microporous ceramic material are formed on a surface and combined tightly, and the heating resistive layer is insufficiently dipped into the smoke oil adsorbed and guided by the microporous ceramic material, so as to provide a good atomization effect, a high degree of reduction of the smoke oil, and a good taste.

In the step (2), the baking temperature of the electrode wet film is 150˜200° C. and the baking time of the electrode wet film is 10˜15 minutes. In the step (3), the sintering temperature is 850˜900° C., and the sintering time is 30˜60 minutes.

In the step (4), the heating resistive wet film comprises the following raw materials in parts by weight: 80˜88 parts of a mixed silver-palladium metallic powder, 2˜3 parts of an adhesive aid, and 8˜12 parts of an organic carrier, wherein the mixed silver-palladium metallic powder is composed of a silver powder and a palladium powder in a weight ratio of (3.9˜4.1):1, and the adhesive aid is at least one selected from the group consisting of boron oxide, silicon oxide and aluminum oxide.

In the present invention, a rare metal (palladium) is added into the silver powder to improve the bonding strength of the heating resistive film with the microporous ceramic substrate and increasing the anti-oxidation dry-burn resistance while maintaining good conductivity, and at least one of the boron oxide, silicon oxide and aluminum oxide is used as an adhesive aid to assist improving the bonding strength of the heating electrode layer with the microporous ceramic substrate. The adhesive aid has terpineol and ethyl cellulose added into a liquid binder to serve as a main body binder, and lecithin is added to heating film slurry with better mobility to improve the printing leveling performance. The raw materials can improve the bonding strength of the heating film with the ceramic body to improve the anti-oxidation dry-burn resistance, so as to extend the service life and improve the using reliability.

Further, each part of the organic carrier comprises the following raw materials in parts by weight: 18˜22 parts of ethyl cellulose, 2˜3.5 parts of lecithin and 76˜79 parts of an organic solvent, wherein the organic solvent is at least one selected from the group consisting of terpineol and butyl carbitol acetate. Further, the organic solvent is composed of terpineol and butyl carbitol acetate in a weight ratio of (3˜4):1.

In the present invention, ethyl cellulose is added into an organic carrier to achieve a thickening effect, and terpineol, butyl carbitol acetate and lecithin are added to obtain heating film slurry with a better mobility and improve the printing leveling performance for an easy printing. The aforementioned selected recipe of the raw materials of the organic carrier can prevent the organic carrier made of the heating resistive layer from being volatilized easily or increasing the viscosity excessively. On the other hand, this recipe also prevents the carrier volatility from being too small and the baked/dried heating resistive layer from being too wet and resulting in an even film edge in the sintering process. Since the volatilization of the organic carrier of the film is centralized, therefore there are more flaws such as surface flaws and pin holes that affect the conductivity and bonding strength of the microporous ceramic substrate. In the heating resistive film, the raw materials can improve the bonding strength of the heating resistive film with the microporous ceramic substrate and the anti-oxidation dry-burn resistance, so as to extend the service life and enhance the using reliability.

In the step (4), the heating resistive wet film has a baking temperature of 150˜200° C. In the step (5), the microporous ceramic thick-film heating element semi-finished product has a baking temperature of 150-200° C. and a baking time of 10-15 minutes. By setting the baking temperature, the heating resistive wet film will not be deformed easily, and the heating resistive layer can be decreased to overcome the issue of having too-many surface flaws and pin holes caused by the centralized volatilization of the solvent, and the bonding strength of the heating resistive layer with the microporous ceramic substrate can be improved.

In the step (6), the microporous ceramic thick-film heating element semi-finished product has a sintering temperature of 850˜900° C. and a sintering time of 30˜60 minutes. By setting the sintering temperature, eutectic bonds formed on the surfaces of the heating resistive layer, the electrode layer and the microporous ceramic substrate are combined closely, so that the lead pin can be operated at a high temperature of 450° C. without falling off, or becoming oxidized or blackened.

Therefore, the present invention has the following advantages and effects: The present invention uses the thick film formation process to form the electrode layer and the heating resistive layer on the microporous ceramic substrate. The microporous ceramic substrate of the present invention has a powerful strength and can be dipped into the smoke oil for a long time without producing porcelain powder. The present invention uses the thick-film technology and a very stable silver-palladium rare metal to prepare the heating resistive layer, and the materials have a lower resistance temperature coefficient and a good stability and can generate heat stably at a high operating temperature and will not be oxidized easily, so that the service life is long. The heating resistive layer of the present invention is processed with a precision silk screen printing and sintered on a surface of the microporous ceramic material surface at high temperature, so that the heating resistive layer and the microporous ceramic material can be combined closely, and the smoke oil adsorbed and guided by the microporous ceramic material can infiltrate the heating resistive layer sufficiently, so as to provide excellent atomization effect and high degree of reduction of the smoke oil.

The manufacturing method of the microporous ceramic thick-film heating element of the present invention has the advantages of simple, highly efficient, and convenient operation and control, easy mass production, stable quality, and long service life.

### BRIEF DESCRIPTION OF THE DRAWINGS

FIG. 1 is a schematic view of a conventional atomizer heating element adopting an oil guide cotton or a fiberglass string wound around a nickel-chromium alloy heating wire;

FIG. 2 is a schematic view of a conventional atomizer heating element adopting a porous ceramic wound around a nickel-chromium alloy heating wire;

FIG. 3 is a schematic view of a conventional atomizer heating element adopting a porous ceramic sintered with a nickel-chromium alloy heating wire;

FIG. 4 is a perspective view of the present invention;

FIG. 5 is an exploded view of the present invention;

FIG. 6 is a top view of the present invention;

FIG. 7 is a top view of a microporous ceramic substrate of the present invention; and

FIG. 8 is a cross-sectional view of Section A-A of FIG. 7.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

### Embodiment 1

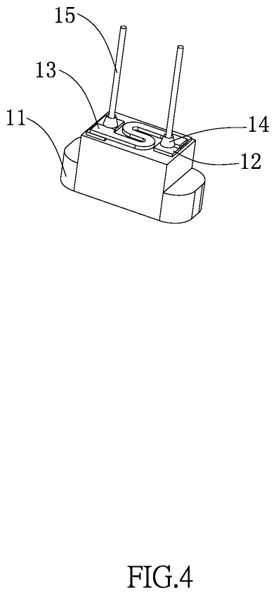

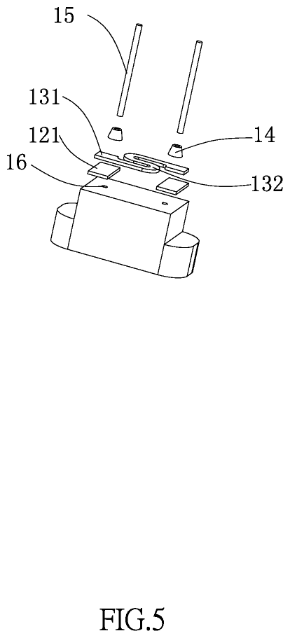

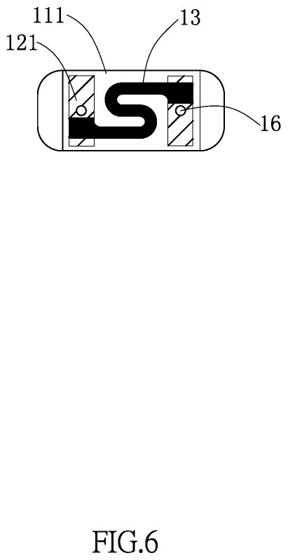

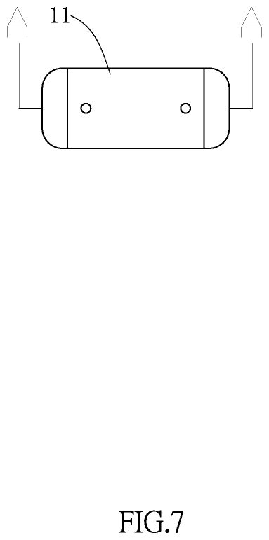

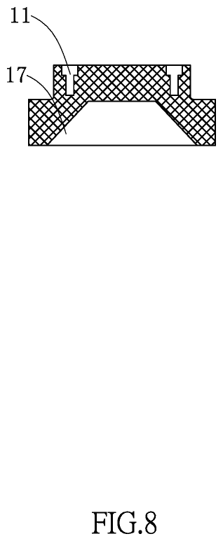

With reference to FIGS. 4 to 8 for a microporous ceramic thick-film heating element for an electronic cigarette oil atomizing core in accordance with the first embodiment of the present invention, the microporous ceramic thick-film heating element comprises a microporous ceramic substrate 11, a heating resistive layer 13, and an electrode layer 12 coupled to an upper surface of the microporous ceramic substrate 11, and the heating resistive layer 13 includes a middle portion 131 and two connecting portions 132 disposed at both ends of the middle portion 131 respectively, and the electrode layer 12 includes two separate electrode films 121, and the two connecting portions 132 are coupled to upper ends of the two electrode films 121 respectively, and the middle portion 131 is coupled to an upper surface of the microporous ceramic substrate 11, and the heating resistive layer 13 is provided for heating the microporous ceramic substrate 11, so that the smoke oil of the electronic cigarette can be atomized and dispersed from the micropore of the microporous ceramic substrate 11.

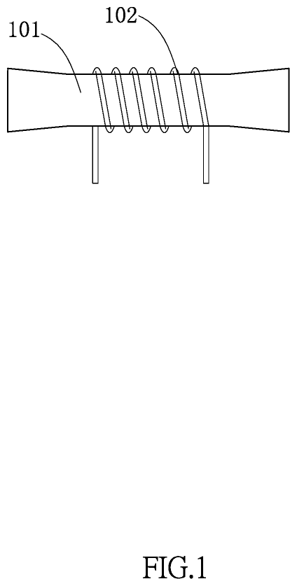

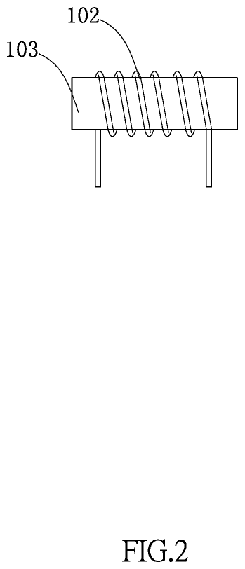

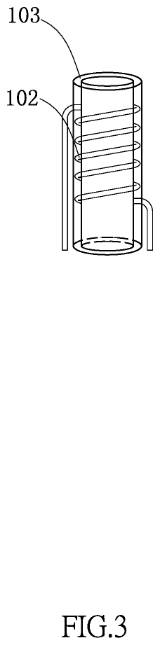

With reference to FIGS. 1 to 3 for a conventional atomizer heating element, the present invention overcomes the following problems of the conventional atomizer heating element: The oil guide cotton or fiberglass string 101 of the heating product comprising the nickel-chromium alloy heating wire 102 wound with oil guide cotton or fiberglass string 101 are burned or charred easily. The porous ceramic 103 wound with the nickel-chromium alloy heating wire 102 has insufficient heating contact, and the heating wire is insufficiently dipped into the smoke oil, so that the operating temperature of the heating wire is too high, and the smoke oil is burned and charred. The porous ceramic 103 wound with the nickel-chromium alloy heating wire nickel-chromium alloy heating wire 102 has the issue of porcelain powder.

Further, the electrode film 121 is printed onto the upper surface of the ceramic carrier, and the electrode film 121 and the microporous ceramic substrate 11 are combined together by sintering. The heating resistive layer 13 is printed onto the upper surfaces of the microporous ceramic substrate 11 and the electrode film 121, and the heating resistive layer 13 is coupled to the electrode film 121 and the microporous ceramic substrate 11 by sintering.

Further, the microporous ceramic thick-film heating element further comprises two lead pins 15, and the microporous ceramic substrate 11 has two positioning blind holes 16, and the two electrode films 121 are disposed above the two positioning blind holes 16 respectively, and lower ends of the two lead pins 15 are passed through the two electrode films 121 and inserted into the two positioning blind holes 16, and the two lead pins 15 are soldered with the two electrode films 121 respectively.

Further, the microporous ceramic thick-film heating element comprises two separate silver paste soldering portions 14, and lower ends of the two silver paste soldering portions 14 are coupled to the upper surfaces of the two electrode films 121 respectively, and lower ends of the two lead pins 15 are passed through the silver paste soldering portion 14 and the electrode film 121 sequentially and inserted into the two positioning blind holes 16 respectively. The silver paste soldering portion 14 is used for sintering and fixing the lead pin 15 to the electrode layer 12 and the microporous ceramic thick-film.

Further, the microporous ceramic substrate 11 has a storage blind slot 17 concavely formed at the lower end of the microporous ceramic substrate 11 and provided for receiving a smoke oil of an external electronic cigarette, wherein the heating resistive layer 13 is provided for heating the microporous ceramic substrate 11, so that the smoke oil in the storage blind slot 17 is atomized and dispersed from a micropore of the microporous ceramic substrate 11 to the outside.

Further, the storage blind slot 17 is in a prismatic, truncated, or elliptical shape, and the lower end of the storage blind slot 17 has a hole diameter greater than the hole diameter of the upper end of the storage blind slot 17.

Further, the microporous ceramic thick-film heating element comprises two separate silver paste soldering portions 14, and lower ends of the two silver paste soldering portions 14 are coupled to upper surfaces of the two electrode films 121 respectively, and lower ends of the two lead pins 15 are passed through the silver paste soldering portion 14 and the electrode film 121 sequentially and inserted into the two positioning blind holes 16 respectively. The silver paste soldering portion 14 is used for sintering and fixing the lead pin 15 to the electrode layer 12 and the microporous ceramic thick-film.

Further, the microporous ceramic substrate 11 is in an inverted hollow T-shape, and a boss 111 is formed at the middle of the upper end of the microporous ceramic substrate 11, and the electrode film 121, the heating resistive film, and the silver paste soldering portion 14 are disposed at the boss 111, and the two positioning blind holes are symmetrically formed at the boss 111. Further, the middle portion 131 is S-shaped, and the connecting portion 132 has a width greater than the width of the middle portion 131, and the electrode film 121 has a width greater than the width of the connecting portion 132. Since the width of the connecting portion 132 is increased, the connecting portion 132 can be coupled to the electrode film 121 securely, and the electrode film 121 has a cross-sectional area greater than the hole diameter of the positioning blind hole 16 to guarantee that the lead pin 15 can extend into the positioning blind hole 16 after passing through the electrode film 121, so that the outer surface of the electrode lead can be electrically conducted with the electrode film 121 very well.

Further, the microporous ceramic substrate 11 has a through porosity of 58%, and the micropore has a hole diameter of 10˜15 μM.

The manufacturing method of the aforementioned microporous ceramic thick-film heating element for an electronic cigarette oil atomizing core comprises the following steps:

(1) Prepare a microporous ceramic substrate 11.

(2) Print a material used for manufacturing an electrode layer 12 on an upper surface of the microporous ceramic substrate 11 to form an electrode wet film, and bake/dry the printed electrode wet film at a baking temperature of 180° C. for a baking time of 12 minutes to obtain an electrode initial layer with a thickness of 18˜19 μM.

(3) Sinter the baked/dried electrode initial layer to obtain an electrode layer 12, wherein the electrode layer 12 includes two separate electrode films 121, each having a thickness of 12˜13 μM.

(4) Use a thick film formation process to print a heating resistive wet film on an upper surface of the microceramic substrate and an upper surface of the electrode layer 12, and connect two connection parts 132 of the heating resistive wet film to upper surfaces of the two electrode films 121 respectively, and bake/dry the printed heating resistive wet film at a baking temperature of 180° C. for a baking time of 12 minutes to obtain a heating resistive initial film with a thickness of 70˜75 μM.

(5) Use a thick film formation process and apply a silver solder paste onto upper surfaces of the two electrode films 121 and at positions corresponding to the areas around the positioning blind hole 16 to prepare a silver paste soldering portion 14, and pass a lead pin 15 through the silver paste soldering portion 14 and the electrode film 121 sequentially and insert the lead pin 15 into the positioning blind hole 16 to obtain a microporous ceramic thick-film heating element semi-finished product, and put the microporous ceramic thick-film heating element semi-finished product into a drying furnace for baking/drying at a baking temperature of 180° C. for a baking time of 12 minutes.

(6) Sinter the baked/dried microporous ceramic thick-film heating element semi-finished product to obtain a heating resistive layer 13 with a thickness of 50˜52 μM.

(7) Perform a precision processing of the microporous ceramic thick-film heating element semi-finished product and use performance test and external inspection to obtain a microporous ceramic thick-film heating element.

Further, the electrode layer 12 is primarily made of silver with a mass percentage of 80˜88%, and the remaining content is a binder, and the material used for making the electrode layer 12 has good conductivity and can be attached to the microporous ceramic substrate 11 securely.

In the step (3), the sintering temperature is 850° C., and the sintering time is 60 minutes.

In the step (4), the heating resistive wet film comprises the following raw materials in parts by weight: 85 parts of a mixed silver-palladium metallic powder, 2.5 parts of an adhesive aid, and 10 parts of an organic carrier, wherein the mixed silver-palladium metallic powder is composed of a silver powder and a palladium powder in a weight ratio of 4:1; and the adhesive aid is composed of boron oxide, silicon oxide, and aluminum oxide in a mass proportion of 1:1:1.

Further, each part of the organic carrier comprises the following raw materials in parts by weight: 20 parts of ethyl cellulose, 2.5 parts of lecithin, and 76˜79 parts of an organic solvent, wherein the organic solvent is composed of terpineol and butyl carbitol acetate in a weight ratio of 3.5:1.

In the step (6), the sintering temperature of the microporous ceramic thick-film heating element semi-finished product is 850° C., and the sintering time of the microporous ceramic thick-film heating element semi-finished product is 60 minutes.

### Embodiment 2

In this embodiment, The manufacturing method of the microporous ceramic thick-film heating element for an electronic cigarette oil atomizing core comprises the following steps:

(1) Prepare a microporous ceramic substrate 11.

(2) Print a material used for manufacturing an electrode layer 12 on an upper surface of the microporous ceramic substrate 11 to form an electrode wet film, and bake/dry the printed electrode wet film at a baking temperature of 150° C. for a baking time of 15 minutes to obtain an electrode initial layer with a thickness of 20˜22 μM.

(3) Sinter the baked/dried electrode initial layer to obtain an electrode layer 12, wherein the electrode layer 12 includes two separate electrode films 121, each having a thickness of 14˜15 μM.

(4) Use a thick film formation process to print a heating resistive wet film on an upper surface of the microceramic substrate and an upper surface of the electrode layer 12, and connect two connection parts 132 of the heating resistive wet film to upper surfaces of the two electrode films 121 respectively, and bake/dry the printed heating resistive wet film at a baking temperature of 150° C. for a baking time of 15 minutes to obtain a heating resistive initial film with a thickness of 75˜80 μM.

(5) Use a thick film formation process and apply a silver solder paste onto upper surfaces of the two electrode films 121 and at positions corresponding to the areas around the positioning blind hole 16 to prepare a silver paste soldering portion 14, and pass a lead pin 15 through the silver paste soldering portion 14 and the electrode film 121 sequentially and insert the lead pin 15 into the positioning blind hole 16 to obtain a microporous ceramic thick-film heating element semi-finished product, and put the microporous ceramic thick-film heating element semi-finished product into a drying furnace for baking/drying at a baking temperature of 150° C. for a baking time of 15 minutes.

(6) Sinter the baked/dried microporous ceramic thick-film heating element semi-finished product to obtain a heating resistive layer 13 with a thickness of 56˜60 μM.

(7) Perform a precision processing of the microporous ceramic thick-film heating element semi-finished product and use performance test and external inspection to obtain a microporous ceramic thick-film heating element.

In this embodiment, the microporous ceramic substrate 11 has a through porosity of 50%, and the micropore has a hole diameter of 15˜20 μM.

Further, the electrode layer 12 is primarily made of silver with a mass percentage of 80˜88%, and the remaining content is a binder, and the material used for making the electrode layer 12 has good conductivity and can be attached to the microporous ceramic substrate 11 securely.

Further, the electrode layer 12 is primarily made of a silver-palladium rare metal, whose mass percentage is 80˜88%, and the remaining content is a binder, and the material used for making the electrode layer 12 has good conductivity and can be attached to the microporous ceramic substrate 11 securely.

In the step (3), the sintering temperature is 850° C., and the sintering time is 60 minutes.

In the step (4), the heating resistive wet film comprises the following raw materials in parts by weight: 80 parts of a mixed silver-palladium metallic powder, 2 parts of an adhesive aid, and 8 parts of an organic carrier, wherein the mixed silver-palladium metallic powder is composed of a silver powder and a palladium powder in a weight ratio of 3.9:1; and the adhesive aid is composed of boron oxide, silicon oxide, and aluminum oxide in a mass proportion of 1:2:1.5.

Further, each part of the organic carrier comprises the following raw materials in parts by weight: 18 parts of ethyl cellulose, 2 parts of lecithin, and 76 parts of an organic solvent, wherein the organic solvent is composed of terpineol and butyl carbitol acetate in a weight ratio of 3:1.

In the step (6), the sintering temperature of the microporous ceramic thick-film heating element semi-finished product is 850° C., and the sintering time of the microporous ceramic thick-film heating element semi-finished product is 60 minutes.

The remaining content of this embodiment is the same as that of the first embodiment, and thus will not be repeated.

### Embodiment 3

In this embodiment, the microporous ceramic substrate 11 has a through porosity of 60%, and the micropore has a hole diameter of 14˜16 μM.

In the step (2), the baking temperature of the electrode wet film is 200° C., and the baking time of the electrode wet film is 10 minutes. In the step (3), the sintering temperature is 850° C., and the sintering time is 60 minutes.

In the step (4), the heating resistive wet film comprises the following raw materials in parts by weight: 88 parts of a mixed silver-palladium metallic powder, 3 parts of an adhesive aid, and 12 parts of an organic carrier, wherein the mixed silver-palladium metallic powder is composed of a silver powder and a palladium powder in a weight ratio of 4:1, and the adhesive aid is composed of boron oxide, silicon oxide and aluminum oxide with a mass proportion of 1:1.2:2.

Further, each part of the organic carrier comprises the following raw materials in parts by weight: 22 parts of ethyl cellulose, 3.5 parts lecithin, and 79 parts of an organic solvent, wherein the organic solvent is composed of terpineol and butyl carbitol acetate in a weight ratio of 4:1.

In the step (4), the baking temperature of the heating resistive wet film is 200° C., and the baking time of the heating resistive wet film is 10 minutes. In the step (5), the baking temperature of the microporous ceramic thick-film heating element semi-finished product is 200° C., and the baking time of the microporous ceramic thick-film heating element semi-finished product is 10 minutes. In the step (6), the sintering temperature of the microporous ceramic thick-film heating element semi-finished product is 850° C., and the sintering time of the microporous ceramic thick-film heating element semi-finished product is 60 minutes.

The remaining content of this embodiment is the same as that of the first embodiment, and thus will not be repeated.

### Embodiment 4

In this embodiment, the heating resistive layer 13 manufactured in the step (4) and the silver paste soldering portion 14 and lead pin 15 manufactured in the step (5) are sintered separately. The heating resistive layer 13 manufactured in the step (4) is formed by being sintered in a high-temperature furnace at 850° C. for a sintering time of 60 minutes first, and then the step (5) is carried out to manufacture the silver paste flux part and the lead pin 15 by an adhesive dispensing technology, and then sintered in a high-temperature furnace at 850° C. for a sintering time of 60 minutes.

The remaining content of this embodiment is the same as that of the first embodiment, and thus will not be repeated.

### Embodiment 5

In this embodiment, the microporous ceramic substrate 11 has a through porosity of 54%, and the micropore has a hole diameter of 16˜20 μM.

In the step (2), the baking temperature of the electrode wet film is 190° C., and the baking time of the electrode wet film is 13 minutes. In the step (3), the sintering temperature is 900° C., and the sintering time is 30 minutes.

In the step (4), the baking temperature of the heating resistive wet film is 190° C., and the baking time of the heating resistive wet film is 12 minutes. In the step (6), the sintering temperature of the microporous ceramic thick-film heating element semi-finished product is 900° C., and the sintering time of the microporous ceramic thick-film heating element semi-finished product is 30 minutes.

The remaining content of this embodiment is the same as that of the first embodiment, and thus will not be repeated.

In the microporous ceramic thick-film heating element for the electronic cigarette oil atomizing core of the present invention, an operating voltage of 2.0 Vdc˜3.7 Vdc is applied, and the withstandable temperature is up to 450° C., and the duration of the dry burn test is up to 30 seconds, wherein the heating film will not be oxidized, burned, or damaged. After 1.2 times of the operating voltage is applied, the electricity is on for 5 seconds, and a loop test is disconnected for 3 seconds (in a smoke oil test), the microporous ceramic thick-film heating element can withstand more than 800 times of the loop test, and it shows that the microporous ceramic thick-film heating element has the advantage of a long service life.

The heating resistive film manufactured according to the manufacturing method of the present invention has a stable performance, a resistance temperature coefficient of 100˜200 ppm/° C., and a resistance range of 0.9˜1.2Ω. A stable heating effect can be achieved at a high operating temperature, and the material used for the lead pin 15 of the present invention is pure silver with good conductivity and the lead pin 15 can be sintered onto the microporous ceramic substrate 11 through the high temperature silver paste at 850˜900° C., so that the lead pin 15 can work at a high temperature of 450° C. without falling off or being oxidized or blackened, and its adhesion strength with the microporous ceramic substrate 11 is over 10N.

In the present invention, the heating film and the electrode film 121 are printed on a surface of the microporous ceramic material surface by precision silk screening printing, and sintered at a high temperature of 850° C., so that eutectic bonds are formed on surfaces of the heating film and the electrode film 121 and the microporous ceramic material to provide a tight combination. The adhesion strength of the films is over 10N.

The manufacturing method of the microporous ceramic thick-film heating element of the present invention has the advantages of simple, highly efficient and convenient operation and control, easy mass production, stable quality, long service life, and good experience of use.

What is claimed is:

1. A microporous ceramic thick-film heating element for an electronic cigarette oil atomizing core, comprising a microporous ceramic substrate, a heating resistive layer and an electrode layer coupled to an upper surface of the microporous ceramic substrate, and the heating resistive layer including a middle portion and two connecting portions disposed at both ends of the middle portion respectively, and the electrode layer including two separated electrode films, and the two connection parts being coupled to upper ends of the two electrode films respectively, and the middle portion being coupled to an upper surface of the microporous ceramic substrate; the heating resistive layer being provided for heating the microporous ceramic substrate to atomize a smoke oil of an electronic cigarette and discharge the atomized smoke oil from the microporous ceramic substrate to the outside.

2. The microporous ceramic thick-film heating element for an electronic cigarette oil atomizing core according to claim 1, wherein the microporous ceramic thick-film heating element further comprises two lead pins, and the microporous ceramic substrate has two positioning blind holes and two electrode films covering the surrounding of the two positioning blind holes respectively, and lower ends of the two lead pins are inserted into the two positioning blind holes respectively and soldered with the two electrode films, and the lead pin is a silver lead pin.

3. The microporous ceramic thick-film heating element for an electronic cigarette oil atomizing core according to claim 1, wherein the microporous ceramic substrate has a storage blind slot formed at the bottom of the microporous ceramic substrate and provided for receiving a smoke oil of an external electronic cigarette, and the heating resistive layer is provided for heating the microporous ceramic substrate to atomize the smoke oil contained in the storage blind slot and dispersing from a micropore to the outside.

4. The microporous ceramic thick-film heating element for an electronic cigarette oil atomizing core according to claim 2, wherein the microporous ceramic thick-film heating element further comprises two separated silver paste soldering portions, and lower ends of the two silver paste soldering portions are coupled to upper surfaces of the two electrode films respectively, and lower ends of the two lead pins are passed sequentially through the corresponding silver paste soldering portion and electrode film and inserted into the two positioning blind holes respectively.

5. The microporous ceramic thick-film heating element for an electronic cigarette oil atomizing core according to claim 1, wherein the microporous ceramic substrate has a through porosity of 50˜60%, and the micropore has a hole diameter of 10˜20 μM.

6. A manufacturing method of the microporous ceramic thick-film heating element for an electronic cigarette oil atomizing core according to claim 4, comprising the steps of:
(1) preparing a microporous ceramic substrate;
(2) printing a material used for an electric layer onto an upper surface of the microporous ceramic substrate to form an electrode wet film, and baking and drying the printed electrode wet film to obtain an electrode initial layer;
(3) sintering the baked and dried electrode initial layer to obtain an electrode layer, wherein the electrode layer includes two separated electrode films;
(4) using a thick film formation process to print a heating resistive wet film onto upper surfaces of a microceramic substrate and the electrode layer, and connecting two connection parts of the heating resistive wet film with upper surfaces of the two electrode films respectively and baking and drying the printed heating resistive wet film;
(5) applying a silver solder paste to an area around a positioning blind hole configured to be corresponsive to an upper surface of the two electrode films to prepare a silver paste soldering portion, and passing a lead pin through the silver paste soldering portion and the electrode film and inserting the lead pin into the positioning blind hole to obtain a microporous ceramic thick-film heating element semi-finished product, and baking and drying the microporous ceramic thick-film heating element semi-finished product;
(6) sintering the microporous ceramic thick-film heating element semi-finished product; and
(7) performing a finishing of the microporous ceramic thick-film heating element semi-finished product, and obtaining the microporous ceramic thick-film heating element through a performance test and visual inspection.

7. The manufacturing method of a microporous ceramic thick-film heating element for an electronic cigarette oil atomizing core according to claim 6, wherein the electrode wet film has a baking temperature of 150˜200° C. in the step (2), and a sintering temperature of 850˜900° C. in the step (3).

8. The manufacturing method of a microporous ceramic thick-film heating element for an electronic cigarette oil atomizing core according to claim 6, wherein the heating resistive wet film in the step (4) comprises raw materials in parts by weight consisting of 80˜88 parts of a mixed silver-palladium metallic powder, 2˜3 parts of an adhesive aid, and 8˜12 parts of an organic carrier, and the mixed silver-palladium metallic powder is composed of a silver powder and a palladium powder in a weight ratio of (3.9˜4.1):1; and the adhesive aid is at least one selected from the group consisting of boron oxide, silicon oxide, and aluminum oxide.

9. The manufacturing method of a microporous ceramic thick-film heating element for an electronic cigarette oil atomizing core according to claim 8, wherein each part of the organic carrier comprises raw materials in parts by weight consisting of 18˜22 parts of ethyl cellulose, 2˜3.5 parts of lecithin, and 76˜79 parts of an organic solvent, and the organic solvent is at least one selected from the group consisting of terpineol and butyl carbitol acetate.

10. The manufacturing method of a microporous ceramic thick-film heating element for an electronic cigarette oil atomizing core according to claim 6, wherein the microporous ceramic thick-film heating element semi-finished product in the step (6) has a sintering temperature of 850˜900° C.
